(19) United States
(12) Patent Application Publication
(10) Pub. No.: US 2017/0323255 A1
(43) Pub. Date: Nov. 9, 2017

(54) SYSTEMS AND METHODS FOR INTERMODAL LOGISTICS

(71) Applicant: TTS Worldwide LLC, Westbury, NY (US)

(72) Inventor: Michael Katzman, Poquott, NY (US)

(73) Assignee: TTS Worldwide LLC, Westbury, NY (US)

(21) Appl. No.: 15/587,741

(22) Filed: May 5, 2017

Related U.S. Application Data
(60) Provisional application No. 62/332,304, filed on May 5, 2016.

(51) Int. Cl. G06Q 10/08; H04L 29/08

(52) U.S. Cl. CPC G06Q 10/0831; H04L 67/10

(57) ABSTRACT

Systems and methods are described herein for facilitating intermodal logistics. A web page that can include an ocean carrier control associated with a list of ocean carriers can be provided to a device. In response, ocean carrier input data characterizing a selected carrier from the predefined list of ocean carriers can be received. One or more input channels can be continuously monitored for gross mass input data characterizing a gross mass of a container associated with a shipment scheduled for the selected carrier. Verification input data can be received that is indicative of a verification of the gross mass of the container. The gross mass input data can be transformed into verified gross mass input data based on a validation of the verification input data. An electronic data interchange message (EDI) can be encoded based on the verified gross mass input data and the ocean carrier input data.

### CROSS-REFERENCED TO RELATED APPLICATION

This application claims the benefit of U.S. Provisional Application No. 62/332,304, filed on May 5, 2016, entitled “System, Methods, and Mobile Devices for Intermodal Logistics,” the content of which is fully incorporated herein by reference.

### TECHNICAL FIELD

This disclosure generally relates to systems and methods for facilitating intermodal logistics. This disclosure more specifically relates to systems and methods that utilize various mobile devices in facilitating intermodal logistics.

### BACKGROUND

The export of cargo, such as manufactured goods, agricultural products, raw materials, and the like, from one nation to another is a common practice that is important to the global economy. The exportation of cargo is regulated by a number of international conventions, treaties, and agreed upon regulations. For example, the International Convention for the Safety of Life at Sea (SOLAS) is an international maritime treaty that regulates safety issues in connection with the exportation of cargo. SOLAS requires transportation vessels sailing under a flag of signatory nations to comply with minimum safety standards with regard to the construction of vessels and transport containers, equipment used on vessels and to load and unload transport containers from vessels, and the general operation of exporting and transporting cargo.

Exportation of cargo typically relies on relatively large intermodal transportation containers that are easily transferred between different modes of transportation, such as ships and other ocean-borne transportation vessels, long-haul semi-trailer trucks, trains, and the like. Such transportation containers are typically large rectangular metal boxes that measure approximately twenty feet (about 6.1 meters) in length, eight feet in width (about 2.4 meters), and eight feet in height (about 2.4 meters).

The International Maritime Organization (IMO) recently amended SOLAS to require the verification of the weight of a packed transportation container. Beginning on Jul. 1, 2016, SOLAS required each transportation container packed with its final contents of exported cargo to have a verified weight associated with the packed container prior to the loading of that container onto a transportation vessel. In this instance, the shipper is ultimately responsible for verifying the weight of each packed transportation container. Thus, the shipper or an agent acting on behalf of the shipper has the responsibility to accurately weigh the packed transportation container or the intended contents of the container to verify the weight of the packed transportation container. The verified weight can be provided to an operator of the transportation vessel, as well as a marine terminal operator prior to loading of the packed container onto the transportation vessel.

Compliance with regulations can be difficult to achieve. For example, the shipper or the agent acting on behalf of the shipper may not be able to timely transmit the weight information for the packed transportation container to the maritime terminal. In some circumstances, the maritime terminal can refuse to load the packed transportation container on the transportation vessel, or may refuse to allow the packed transportation container to be stored at the maritime terminal. Thus, in many instances, failure to timely transmit the weight information for the packed transportation container can lead to supply chain issues, or spoilage of cargo.

Accordingly, a need exists for systems and methods for facilitating intermodal container logistics that comply with international treaties, conventions, and other agreed upon regulations.

### SUMMARY

In one example, a system can include a non-transitory memory that can store machine readable instructions and data, and a processor that can access the non-transitory memory and execute the machine readable instructions. The machine readable instructions can cause the processor to provide a booking web page to a device that can include an ocean carrier control that can be associated with a predefined list of ocean carriers. The predefined list of ocean carriers can be stored in the memory. The machine readable instructions can further cause the processor to receive ocean carrier input data received at the ocean carrier control. The ocean carrier input data can characterize a selected carrier from the predefined list of ocean carriers. The machine readable instructions can further cause the processor to monitor continuously one or more input channels associated with one or more input devices for gross mass input data that can characterize a gross mass of a container associated with a shipment scheduled for the selected carrier. The machine readable instructions can further cause the processor to receive the gross mass input data from the one or more input channels and generate a verification control to verify the gross mass of the container. The verification control can be associated with a verification entity for the container.

The machine readable instructions can further cause the processor to receive verification input data in response to generating the verification control. The verification input data can be indicative of a verification of the gross mass input. The machine readable instructions can further cause the processor to validate that the verification input data is associated with the verification entity, transform the gross mass input data into a verified gross mass input data based on the validation, encode an electronic data interchange message (EDI) based on the verified gross mass input data and the ocean carrier input data, and cause the EDI to be transmitted to a shipping portal to cause the shipping portal to transmit the verified gross mass to a carrier data store associated with the selected carrier and a terminal data store associated with a terminal associated with the selected carrier.

In another example, a system can include a server and a shipping device. The server can include one or more processors and a non-transitory memory that can store machine readable instructions and data. The one or more processors of the server can be configured to access the non-transitory memory and execute the machine readable instructions. The machine readable instructions can cause the one or more processors of the server to provide a booking web page to a booking device that can include an ocean carrier control that can be associated with a predefined list of ocean carriers. The predefined list of ocean carriers can be stored in the memory of the server. The machine readable instructions can cause the one or more processors of the server further to receive ocean carrier input data received at the ocean carrier control. The ocean carrier input data can characterize a selected carrier from the predefined list of ocean carriers.

The machine readable instructions can cause the one or more processors of the server further to monitor continuously one or more input channels associated with one or more input devices for gross mass input data that can characterize a gross mass of a container associated with a shipment scheduled for the selected carrier, receive the gross mass input data from the one or more input channels and generate a verification control to verify the received gross mass input data. The verification control can be associated with a verification entity for the container. The machine readable instructions can cause the one or more processors of the server further to receive verification input data, wherein the verification input data is indicative of a verification of the gross mass input, validate that the verification input data is associated with the verification entity, transform the gross mass input data into a verified gross mass input data based on the validation, encode an EDI based on the verified gross mass input data and the ocean carrier input data, and transmit the EDI to the shipping device.

The shipping device can include one or more processors and a non-transitory memory that can store machine readable instructions and data. The one or more processors of the shipping device can be configured to access the memory of the shipping device and execute the machine readable instructions. The machine readable instructions can cause the one or more processors of the shipping device to receive the EDI transmitted by the server and transmit the verified gross mass to the carrier data store associated with the selected carrier and the terminal data store associated with the terminal associated with the selected carrier based on the received EDI.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically illustrates an exemplary system for facilitating intermodal logistics according to one or more embodiments shown and described herein.

FIG. 2 schematically illustrates and exemplary mobile device according to one or more embodiments shown and described herein.

FIG. 3 schematically illustrates an exemplary database according to one or more embodiments shown and described herein.

FIG. 4 is a flow diagram of an exemplary method for facilitating intermodal logistics according to one or more embodiments shown and described herein.

FIG. 5 schematically illustrates an exemplary booking web page according to one or more embodiments shown and described herein.

FIG. 6 schematically illustrates an exemplary booking detail web page according to one or more embodiments shown and described herein.

FIG. 7 schematically illustrates an exemplary container information control according to one or more embodiments shown and described herein.

FIG. 8 schematically illustrates an exemplary user interface according to one or more embodiments shown and described herein.

FIG. 9 schematically illustrates another exemplary user interface according to one or more embodiments shown and described herein.

FIG. 10 schematically illustrates yet another exemplary user interface according to one or more embodiments shown and described herein.

### DETAILED DESCRIPTION

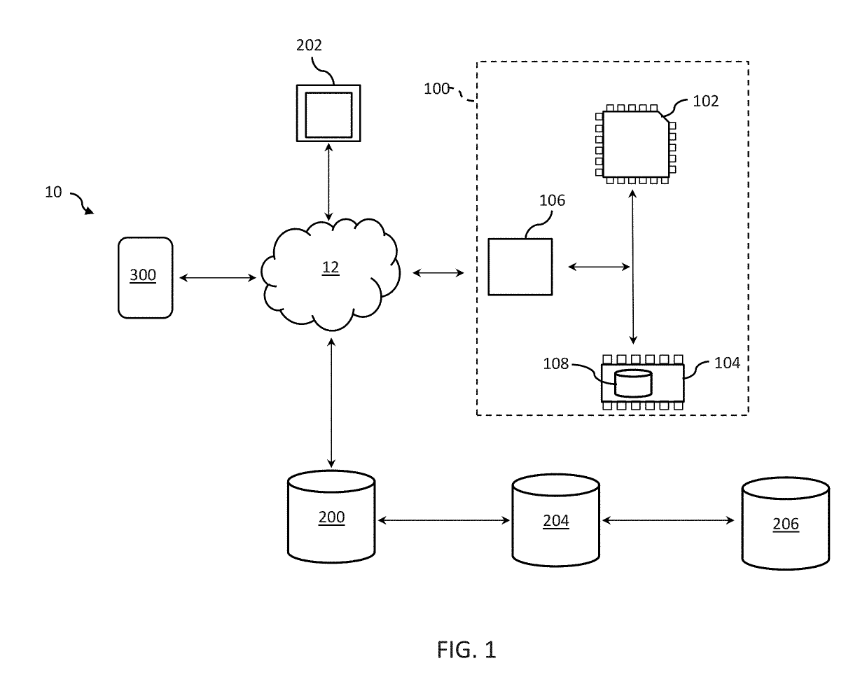

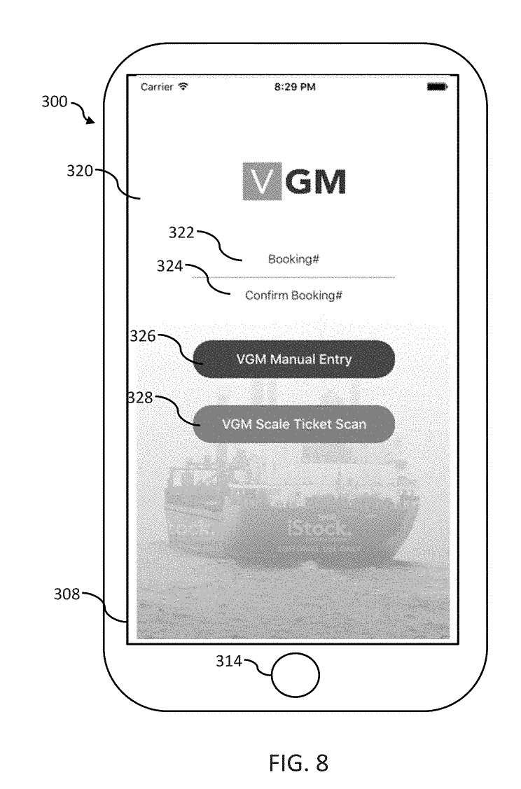

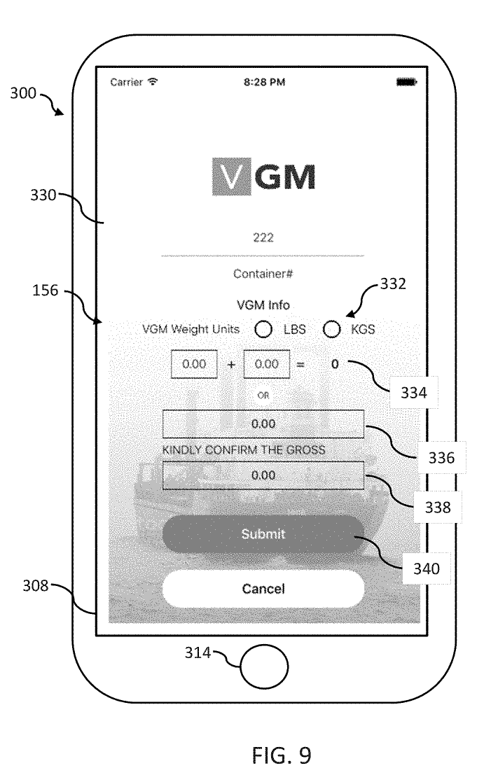

The apparatus, systems, arrangements, and methods disclosed herein are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of systems and methods for facilitating intermodal logistics are hereinafter disclosed and described in detail with reference made to FIGS. 1-10.

FIG. 1 illustrates an exemplary system 10 for facilitating intermodal logistics. The system 10 can be configured to implement methods described herein. The system 10 can include a server 100 and a shipping portal 200. The server 100 can be configured to provide a verified gross mass for a container, such as a shipping container, to the shipping portal 200 based on one or more inputs received from one or more channels.

As described herein, the server 100 can be configured to receive input data from one or more devices operating through the one or more channels, and communicating a verified gross mass to the shipping portal 200. In one example, the server 100 can be configured to communicate the verified gross mass data characterizing the verified gross mass for the container to the shipping portal 200. The server 100 can include one or more processors 102. The one more processors 102 can be configured to execute machine readable instructions to perform one or more functions according to the methods described herein. As used herein, the term “processor” includes any device that can be configured to execute machine readable instructions. Accordingly, each processor can be a controller, an integrated circuit, a microchip, or any other device capable of implementing logic. For example, the one or more processors 102 can include a touch screen controller, a baseband controller, graphics processor, application processor, image processor, or the like.

The server 100 can include memory 104 for storing data and machine readable instructions. The memory 104 can be communicatively coupled to the one or more processors 102 (communicatively coupled is illustrated with a double arrowed lines throughout the figures). The memory 104 can be implemented, for example, as a non-transitory computer storage medium, such as volatile memory (e.g., random access memory), non-volatile memory (e.g., a hard disk drive, a solid-state drive, flash memory or the like) or a combination thereof. In one example, the one or more processors 102 can execute web server software provided as machine readable instructions that can be, for example, stored on the memory 104. Suitable web server software can include, but not limited to, an Apache HTTP Server, Internet Information Services, Nginx, Google Web Server, or the like. Accordingly, the server 100 can utilize a server operating system such as, for example, Unix, Linux, BSD, Microsoft Windows, or the like. The server 100 can be configured to be communicatively coupled with the shipping portal 200 over an Internet 12.

Additionally, it is noted that the functions, modules, and processes described herein can be provided as machine readable instructions stored on the memory 104 that can be executed by the one or more processors 102. The machine readable instructions can be provided in any programming language of any generation (e.g., 1GL, 2GL, 3GL, 4GL, or 5GL) such as, e.g., machine language that may be directly executed by the processor, or assembly language, object-oriented programming (OOP), scripting languages, microcode, etc., that can be compiled or assembled into machine readable instructions and stored on a machine readable medium. Alternatively, the functions, modules, and processes described herein can be written in a hardware description language (HDL), such as logic implemented via one of a field-programmable gate array (FPGA) configuration, an application-specific integrated circuit (ASIC), and their equivalents. Accordingly, the functions, modules, and processes described herein may be implemented in any conventional computer programming language, as pre-programmed hardware elements, or as a combination of hardware and software components.

The one or more processors 102 can further be communicatively coupled to network interface hardware 106. The network interface hardware 106 can be configured to communicatively couple the server 100 to others device via a network such as, for example, a wide area network (WAN), a local area network (LAN), personal area network (PAN), or the like. As used herein, the phrase “communicatively coupled” can mean that components are capable of exchanging data signals with one another such as, for example, electrical signals via a conductive medium, electromagnetic signals via air, optical signals via optical waveguides, and the like. Accordingly, the network interface hardware 106 can be configured to communicate, e.g., send and/or receive data signals via any wired or wireless communication protocol. It is noted that the term “signal,” as used herein, can mean a waveform (e.g., electrical, optical, magnetic, or electromagnetic), such as DC, AC, sinusoidal-wave, triangular-wave, square-wave, and the like, capable of traveling through a medium. For example, the network interface hardware 106 can include at least one of an antenna, a modem, LAN port, a wireless fidelity (Wi-Fi) card, a WiMax card, near-field communication hardware, satellite communication hardware, or the like.

The server 100 can be communicatively coupled to a network via physical wires, the WAN, the LAN, the PAN, a satellite network, or the like. Suitable LANs can include wired Ethernet and/or wireless technologies, such as Wi-Fi. Suitable PANs can include wireless technologies such as, IrDA, BLUETOOTH, Wireless USB, Z-WAVE, ZIGBEE, or the like.

Alternatively or additionally, suitable PANs can include wired computer buses such as, USB and FIREWIRE. Thus, any components of the server 100 can utilize one or more network components to communicate signals via the Internet 12 (i.e., World Wide Web (WWW)). It is noted that, while the server 100 is schematically illustrated in FIG. 1 as being a single machine, each of the one or more processors 102, the memory 104, and the network interface hardware 106 can be distributed amongst a plurality of machines that are communicatively coupled to one another. Accordingly, the server 100 can be scaled to include any number of machines suitable for supporting any number of communication channels.

The shipping portal 200 can be configured to provide one or more channels. The one or more channels can be used to facilitate activities of various entities associated with transporting of cargo being stored in intermodal transportation containers. The shipping portal 200 can be configured to receive, transmit, and decode an Electronic Data Interchange (EDI) message. The EDI message can be representative of documents or information such as, for example, purchase orders, invoices, shipping notices, or the like. The EDI messages can be encoded according to a standard data format such as, for example, Electronic Data Interchange For Administration (EDIFACT), ODETTE, Extensible Markup Language (XML) data format, X12, or the like.

The shipping portal 200 can be configured to enable shippers or freight forwarders to communicate with a plurality of ocean carriers and terminals. As used herein, the term “shipper” can be defined to encompass an entity that owns the cargo being transported such as, but not limited to, a beneficial cargo owner (BCO). Furthermore, the term “shipper” can include an agent authorized by the shipper to act directly on behalf of the shipper. In one example, the shipping portal 200 can include INTTRA, Tradetech, CargoSmart, or the like. Alternatively or additionally, the shipping portal 200 can be provided directly by an ocean carrier or a maritime terminal.

The system 10 can include one or more input channels to the server 100. For example, an input channel can be provided via a client device 202. The client device 202 can be one of a mobile phone, a smart phone, a tablet, a laptop computer, a desktop computer, a specialized machine suitable for accessing webpages, or the like. Alternatively or additionally, an input channel can be provided via a mobile device 300 that can be configured to execute a specific application for providing the input channel such as, for example, a smart phone, a tablet, a wearable device, and the like.

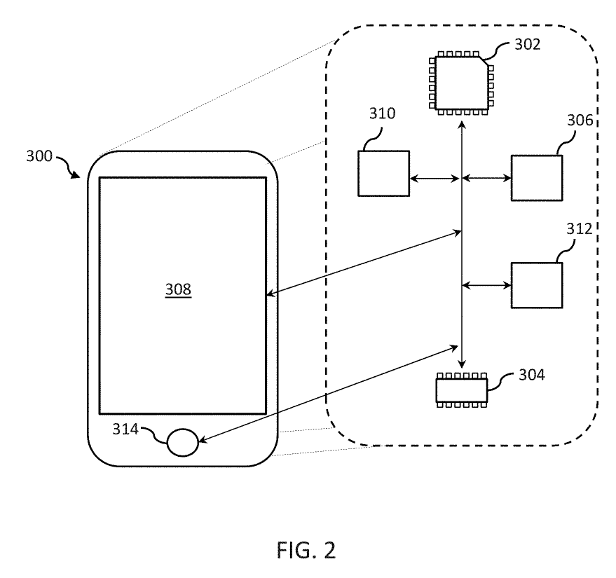

Referring collectively to FIGS. 1 and 2, the mobile device 300 can include one or more processors 302 that can be communicatively coupled to memory 304. The mobile device 300 can be configured to implement a mobile operating system, as machine readable instructions stored on the memory 304 and executed by the one or more processors 302. The mobile operating system can include, but is not limited to, Android, iOS, Blackberry OS, Windows Phone, Symbian, and the like. The mobile device 300 can further include a network interface hardware 306. The network interface hardware 306 can be communicatively coupled to the one or more processors 302 for communicatively coupling the mobile device 300 to another device via a network.

The mobile device 300 can further include a display 308. The display 308 can be communicatively coupled to the one or more processors 302 and can be configured to provide optical signals and convey visual feedback to users of the mobile device 300. In one example, the display 308 can be configured to selectively illuminate a plurality of pixels to provide the optical signals. Accordingly, the display 308 can include light emitting diodes (LED or OLED), liquid crystal display (LCD), liquid crystal on silicon (LCOS), or the like. Additionally or alternatively, the display 308 can be configured to operate as a touch screen and can accept tactile input via visual controls. Accordingly, the display 308 can include a touch detector such as, for example, a resistive sensor, capacitive sensor, or the like. It should be understood that the term “optical” can be defined to include different wavelengths of an electromagnetic spectrum such as, but not limited to, wavelengths in the ultraviolet (UV), infrared (IR), and visible portions of the electromagnetic spectrum.

The mobile device 300 can further include radio frequency (RF) hardware 310. The RF hardware 310 can be communicatively coupled to the one or more processors 302 and can communicatively couple the mobile device 300 with an external network, such as a cellular network. The cellular network can include, but is not limited to, technologies such as, Long-Term Evolution (LTE), Worldwide Interoperability for Microwave Access (WiMAX), Universal Mobile Telecommunication System (UMTS), Code Division Multiple Access (CDMA), or Global System for Mobile Communication (GSM). Additionally or alternatively, the RF hardware 310 can include one or more components that can communicate voice information and data signals such as, for example, modems, attenuators, antennas, antenna switches, amplifiers, receivers, transceivers, or combinations thereof. Accordingly, the mobile device 300 can utilize the cellular network to communicate signals over the Internet 12.

The mobile device 300 can further include an optical sensor 312. The optical sensor 312 can be communicatively coupled to the one or more processors 302 and can be configured to detect optical signals. The optical sensor 312 can further be configured to encode the detected signals into an image (e.g., a still image) or collection of images (e.g., video). The optical sensor 312 can include semiconductor charge-coupled devices (CCD), complementary metal-oxide-semiconductors (CMOS), N-type metal-oxide-semiconductors (NMOS), or the like. The optical sensor 312 can be configured to capture and transmit one or images to the memory 304.

The mobile device 300 can further include one or more input components 314. The one or more input components 314 can be configured to sense tactile input from one or more users and encoding the tactile input into a signal indicative of the tactile input. The one or more input components 314 can include a button, a knob, a switch, a resistive sensor, capacitive sensor, or the like. Alternatively or additionally, the display 308 can be configured to receive user input and operate as the one or more input components 314. In addition to the aforementioned components, the mobile device 300 can include one or more additional components that can be communicatively coupled to the one or more processors 302 without departing from the scope of the embodiments described herein. For example, the one or more additional components can include, but is not limited to, speakers, accessory lights (e.g., an LED), an optical sensor, a Global Positioning System (GPS) receiver, one or more motion sensors, a microphone, a communicatively coupled keyboard, or the like.

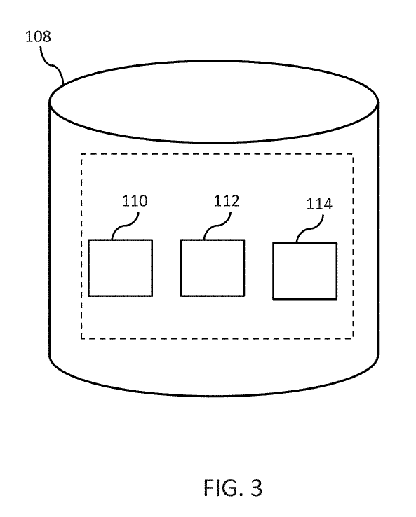

Referring collectively to FIGS. 1 and 3, the server 100 can be configured to access one or more databases 108 for storing multiple data instances in an associated manner. In one example, the database 108 can be stored in the memory 104. The database 108 can include entity data 110 that can characterize a plurality of parties involved in the transport of cargo. For example, the entity data 110 can include shipper data instances corresponding to a shipper. Exemplary shipper data instances can include, but not limited to, payment information, a company name, a company address, a contact name, contact information (e.g., an email address, a cell phone number, etc.), or any other data related to the parties.

In one example, The entity data 110 can further include data instances corresponding to one or more verification entities that can be permitted to provide a verification input. In general, each verification entity can be required to be the shipper or an authorized agent of the shipper. In some examples, the verification entity can be associated with validation credentials (e.g., a user name and password). Alternatively or additionally, the entity data 110 can include data instances corresponding to verification alert parameters. The verification alert parameters can be configured to define a contact information and a message frequency (e.g., a total number, time between messages, etc.). The message frequency can be selectively set to correspond to the needs or preferences of users of the system 10.

In another example, the entity data 110 can include freight forwarder data instances associated with a freight forwarder (e.g., an entity that can transport the cargo from the shipper of the cargo to a maritime terminal). Exemplary freight forwarder data instances can include, but are not limited to, payment information, a company name, a company address, a contact name, contact information (e.g., an email address, a cell phone number, etc.), one or more associated shippers, freight forwarders, or any other relevant information. In an even further example, the entity data 110 can be associated with a plurality of shippers and freight forwarders. Accordingly, the verification alert parameters for each of the shippers can be associated with the freight forwarder data. Alternatively or additionally, the entity data 110 can include a predefined list of ocean carriers. The predefined list of ocean carriers can represent one or more ocean carriers that can interact with the shipping portal 200.

The application database 108 can further include booking data 112. The booking data 112 can characterize a shipment of cargo to be conveyed by an ocean carrier. For example, the booking data 112 can include data instances corresponding to booking numbers, container identification numbers, selected carriers, or the like. Each booking number can be associated with a single shipment that is to be conveyed by carrier given carrier (e.g., a selected carrier). Each shipment can include one or more containers, e.g., each instance of the booking number and selected carrier can be associated with multiple container number instances.

The database 108 can further include weight data 114. The weight data 114 can include data instances corresponding to a gross mass, a verified gross mass, a communication status, a date weighed, a date verified, and weight ticket images. The gross mass for a container can be representative of a mass of a container and the cargo housed therein. The gross mass for the associated container can be determined using calibrated and certified weighing equipment such as, for example, a scale, a weighbridge, lifting equipment or any other device that is capable of determining the gross mass of a packed container or of packages and cargo items, pallets, dunnage and other packing and securing. The verified gross mass can correspond to a gross mass that has been verified by the verification entity of the shipper associated with the container. As is described in greater detail herein, data instances of the database 108 can be created, updated, or deleted via an input channel of the server 100.

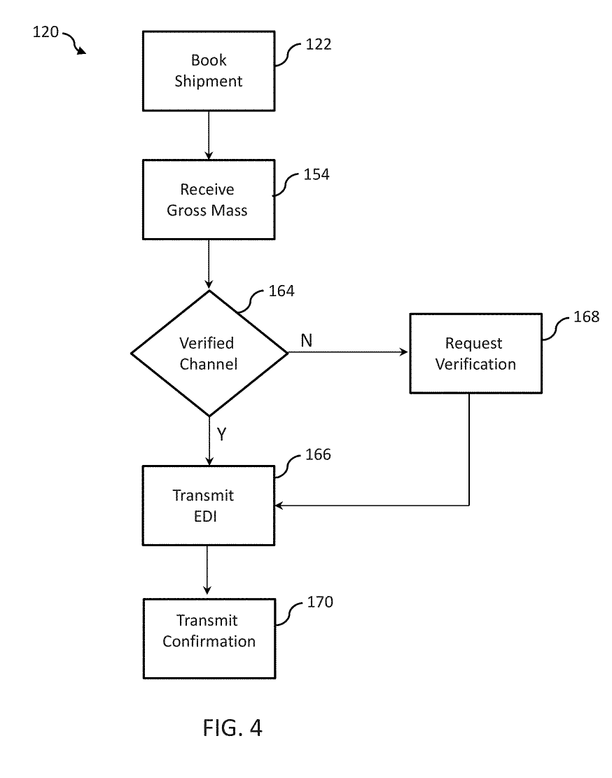

In view of the structural and functional features described herein, a method that can be implemented will be better appreciated with reference to FIG. 4. While, for purposes of simplicity of explanation, the method of FIG. 4 is shown and described as executing serially, it is to be understood and appreciated that such method is not limited by the illustrated order, as some aspects could, in other embodiments, occur in different orders and/or concurrently with other aspects from that shown and described herein. Moreover, not all illustrated features may be required to implement a method. The method or portions thereof can be implemented as instructions stored in one or more non-transitory storage media as well as be executed by a processing resource (e.g., the one or more processors 102) of a computer system, for example, the server 102.

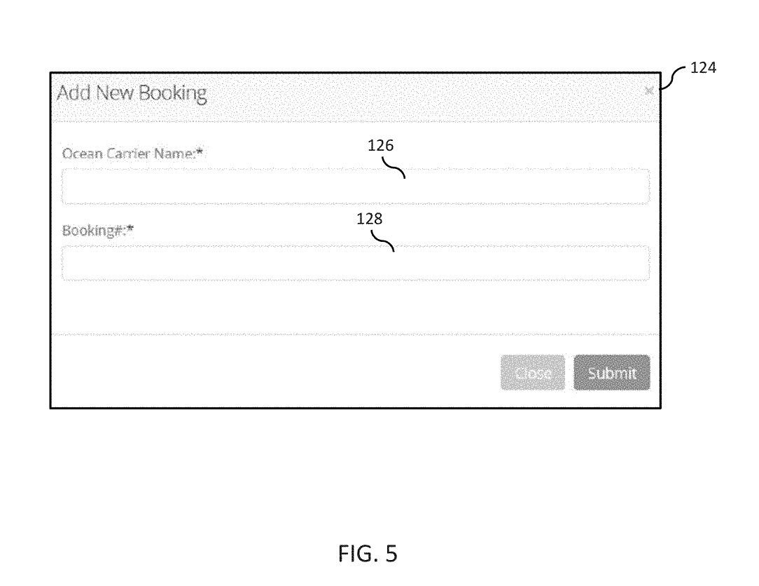

FIG. 4 illustrates an exemplary method 120 for intermodal logistics. The system 10 can be configured to perform the method 120 for intermodal logistics. The method 120 can include a process 122 for booking a shipment including one or more containers. In one example, the server 100 can be configured to deliver a booking web page 124, such as illustrated in FIG. 5, to the client device 202. The server 100 can be configured to populate or alter the booking data 112 based on input received via the booking web page 124. The booking web page 124 can include an ocean carrier control 126. The carrier control 126 can be associated with the predefined list of ocean carriers. The ocean carrier control 126 can receive an ocean carrier input that can be representative of a selected carrier. Additionally or alternatively, the ocean carrier control 126 can be configured to constrain the ocean carrier input to only carriers of the predefined list of ocean carriers, e.g., the selected carrier can be selected from the predefined list of ocean carriers.

Alternatively, the server 100 can be configured to update the predefined list of ocean carriers based upon the ocean carrier control. The booking web page 124 can further include a booking number control 128. The booking number control 128 can be configured to receive a booking number input that can be representative of a shipment booked with the selected carrier. The server 100 can be configured to check a validity of the booking number input. For example, the server 100 can be configured to ensure that the booking number input be unique throughout the entire database 108. In response, the server 100 can be configured to generate data instances in the booking data 112 that associates the booking number input with the selected carrier.

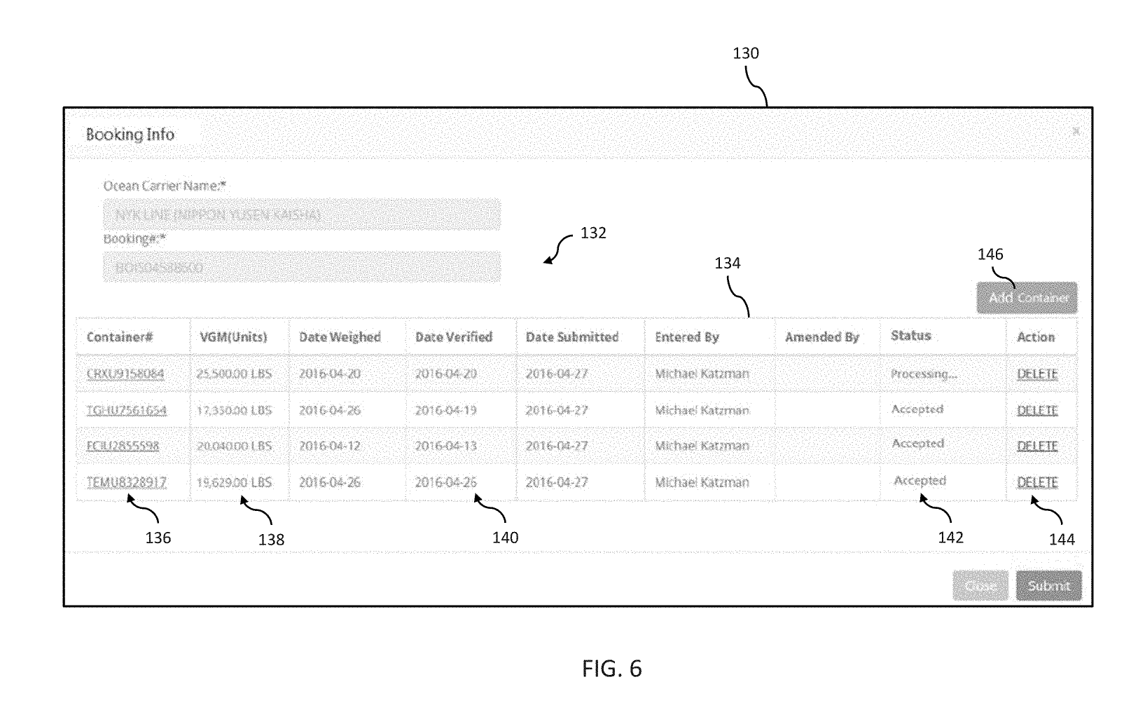

The server 100 can further be configured to deliver a booking detail web page 130 to the client device 202, such as illustrated in FIG. 6. The booking detail web page 130 can include booking detail objects 132 that can provide a visual indicia of the booking data 112, the weight data 114, or both associated with a booking number data instance. For example, the booking detail objects 132 can provide textual information corresponding to the booking number in a table 134. Each row of the table 134 can correspond to a different container number associated with a given container. The columns of the table 134 can correspond to the booking data 112 and the weight data 114 for a plurality of containers. The table 134 can include columns with booking detail objects 132 such as, for example, container number objects 136, gross mass objects 138, verified gross mass objects 140, communication status objects 142, or any other object corresponding to the booking data 112, the weight data 114, or both.

The columns of the table 134 can further include container deletion objects 144. Each container deletion object 144 can be associated with a different container number associated with the given container. The server 100 can be configured to delete the data instances of the database 108 associated with the container number of the container deletion object 144 in response to input received by the container deletion object 144. In one example, the container deletion object 144 can be disabled upon the transmission of an EDI message associated with the container number. In an additional example, the booking detail objects 132 can be updated to reflect updates in the booking data 112, the weight data 114, or both stored in the database 108.

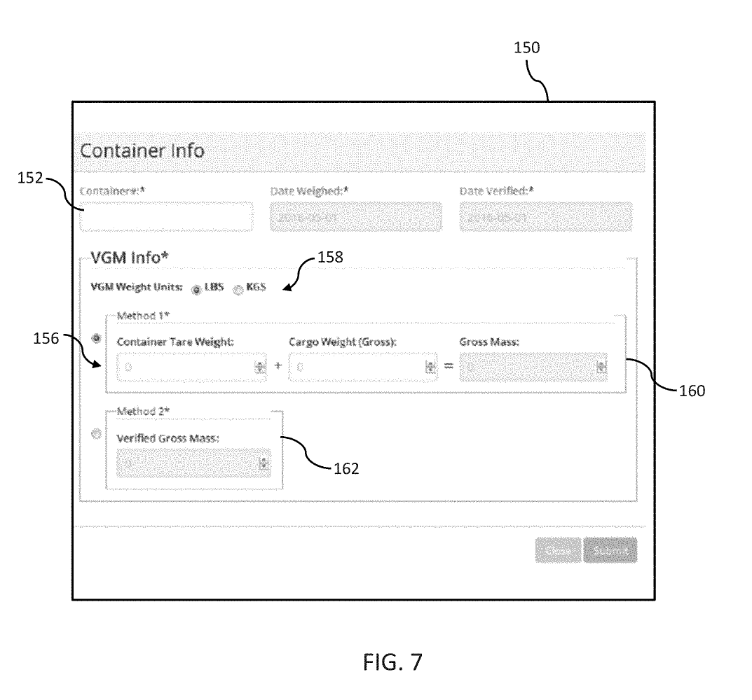

The booking detail web page 130 can further include an add container control 146. The add container control 146 can be configured to receive an input (e.g., user input) in response to which the server 100 can be configured to provide a container information control 150 to the client device 202, such as illustrated in FIG. 7 The container information control 150 can include a container number control 152. The container number control 152 can receive a container number input. The container number input can be associated with a corresponding container that is to be included with the booked shipment. The server 100 can be configured to check the validity of the container number input. For example, the server 100 can be configured to evaluate the container number input relative other container numbers associated with a given booking number and determine if the container number is not being currently utilized.

The method 120 of FIG. 4 can further include a process 154 for receiving a gross mass input. The server 100 can be configured to continuously monitor one more input channels for the gross mass input. The server 100 can be configured receive gross mass input from the client device 202, which can be configured as one of the input channels. For example, the container information control 150 can be configured to receive gross mass input. In some examples, the container information control 150 can be instantiated in response to input received by the add container control 146 of the booking detail web page 130, which can allow the gross mass input to be provided with a newly added container. Alternatively or additionally, the gross mass input can be provided by editing existing container information. Specifically, the container information control 150 can be instantiated in response to input received by one of the booking detail objects 132 such as, for example, the container number object 136. Accordingly, the container information control 150 can be pre-populated with the existing booking data 110 and weight data 114, and can be configured for editing the existing booking data 110 and weight data 114, as described below according to the methods described herein.

The container information control 150 can further include a gross mass control 156. The gross mass control 156 can be configured to receive the gross mass input that can be indicative of the gross mass of the given container associated with a particular container number. The gross mass control 156 can include a unit control object 158. The unit control object 158 can be configured to receive input indicative of the mass units (e.g., pounds, kilograms, or the like).

The gross mass control 156 can further include a tare weight control 160. The tare weight control 160 can be configured to receive gross mass input indicative of the weight of the cargo and the unpacked tare weight of the container. Alternatively or additionally, the gross mass control 156 can further include a packed weight control 162. The packed weight control 162 can be configured to receive gross mass input indicative of the packed weight of the container. In one example, the gross mass control 156 can include a control that can selectively activate one of the tare weight control 160 and the packed weight control 162. In another example, the server 100 can be configured to require that the gross mass input be provided in whole numbers, e.g., no fractional values. Additionally, the server 100 can clear numerical input provided to the gross mass control 156 each time the unit control object 158 receives input to change the units of the gross mass input.

The method 120 of FIG. 4 can further include process 154. The server 100 can be configured, at process 154, to receive the gross mass input from the mobile device 300, which can be configured as one of the input channels. The mobile device 300 can be configured to present a user interface 320 for verifying a given booking number upon the display 308. The user interface 320 can include a booking number control 322. The booking number control 322 can be configured to receive the given booking number in response to user input. The user interface can further include a confirm booking number control 324. The confirm booking number control 324 can be configured to receive additional booking number data in response to the user input. In one example, the mobile device 300 can be configured to evaluate the given booking number to the additional booking number data. The mobile device 300 can compare the given booking number to the additional booking number and require that the booking number input and the additional booking number data match. Additionally, the mobile device 300 can be configured to disable a copy and paste functionality of the mobile with the user interface 320, and specify via the user interface 320 that the input to be provided twice.

The mobile device 300 can further be configured to determine that the inputs match in response to receiving input with the booking number control 322 and the confirm booking number control 324. The mobile device 300 can be configured to query the application database 108 of the server 100 with the booking number input in response to determining that the inputs match. One of the mobile device 300 and the server 100, or both, can be configured to determine if the booking number input matches an existing booking number of the booking data 112 based on the query

The mobile device 300 can further be configured to enable both a manual entry control 326 and an automatic entry control 328 in response to determining that the booking number input matches an existing booking number. Alternatively, the mobile device 300 can be configured to provide an indication that the booking number does not match on the user interface 320, and allow for resubmission of the booking number input in response to determining that the booking number input does not match the existing booking number.

The mobile device 300 can further be configured to present a user interface 330 in response to input received by the manual entry control 326. The user interface 330 can receive the gross mass input upon the display 308. The mobile device 300 can further be configured to require that the gross mass input be provided in whole numbers, i.e., no fractional values. The user interface 330 can include a unit control object 332 that can be configured to receive input indicative of mass units. The user interface 330 can further include a tare weight control 334 that can be configured to receive gross mass input indicative of the weight of the cargo and the unpacked tare weight of the container.

The user interface 330 can further include a packed weight control 336 that can be configured to receive gross mass input indicative of the packed weight of the container. The user interface 330 can further include a confirm packed weight control 336 that can be configured to receive additional gross mass input. In one example, the mobile device 300 can be configured to require that the gross mass input and the additional gross mass input match. Additionally, the mobile device 300 can be configured to disable a copy and paste functionality with the user interface 330, and require that the input is provided twice.

In a further example, the mobile device 300 can be configured to clear a numerical input provided to the user interface 330 each time the unit control object 332 receives input to change the units of the gross mass input. The user interface 330 can activate a confirm control 340 configured to receive confirmation input if the gross mass input is suitable. The mobile device 300 can be configured to submit the gross mass input to the application server 100 to update the gross mass data of the weight data 114 associated with the container number in response to receiving the confirmation input.

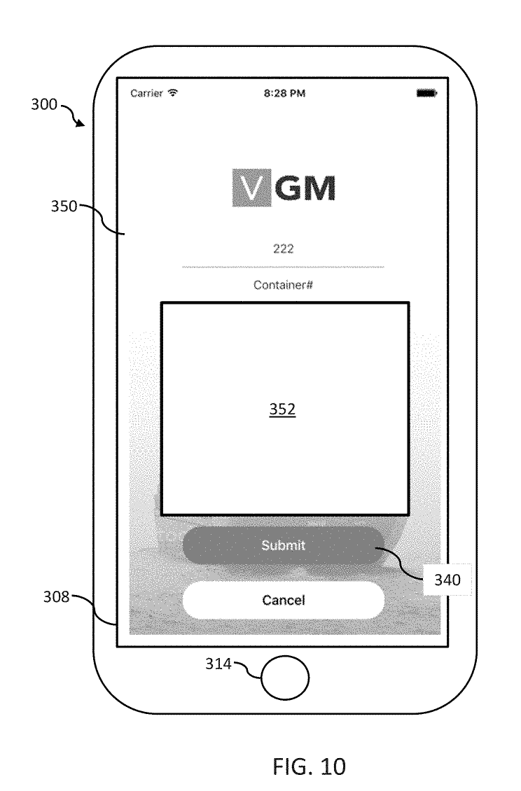

Referring collectively to FIGS. 1, 2, 3, 8, and 10, the mobile device 300 can further be configured to present a user interface 350, such as illustrated in FIG. 10, for scanning a weight ticket upon the display 308 in response to input received by the automatic entry control 326. For example, the mobile device 300 can be configured to extract gross mass input from a weight ticket provided by calibrated and certified weighing equipment. The user interface 350 can include a view finder object 352. The view finder object 352 can be configured to display images detected by the optical sensor 312 of the mobile device 300.

The mobile device 300 can further be configured to capture an image of the weight ticket displayed in the view finder object 352 and execute an optical character recognition engine to extract the gross mass input from the image in response to the input provided upon the display 308 or the input component 314. The mobile device 330 can further be configured to require that the weight ticket image to be captured an additional time or a plurality of additional times. Accordingly, extracted data or the images can be compared to confirm that the gross mass input is suitable. The user interface 330 can be configured to activate a confirm control 340 in response to extracting the gross mass input. The confirm control 340 can be configured to transmit data characterizing the gross mass input, the image, or both to the server 100 to update the weight data 114 associated with the container number.

The method 120 of FIG. 4 can further include a process 164 for determining if the gross mass input is provided by a verified channel. The input channel can be configured to receive validation credentials prior to or after receiving the gross mass input. For example, the client device 202 or the mobile device 300 can be provided with a verification control such as, for example, a log-in interface for receiving verification input. The verification input can be compared to the validation credentials of the entity data 110 of the application database 100. The server 100 can be configured to determine if the verification input is associated with the verification entity of the container based upon a result of the comparison.

The server 100 can be configured to transform the gross mass input into a verified gross mass in the weight data 114 if the gross mass input is provided by an input channel associated with the verification entity. If the gross mass input is provided by an input channel that is not associated with the verification entity, the method 120 can proceed to a process 168 that can request verification from the verification entity. At process 168, the server 100 can be configured to transmit a verification request to the verification entity according to the verification alert parameters of the entity data 110. For example, the verification request can be an email, a text message, or the like.

In one example, the server 100 can be configured to generate a unique uniform resource locator (URL) corresponding to a verification webpage associated with the container. The unique URL can be embedded within the verification request. The server 100 can be configured to deliver a verification webpage having one or more verification controls for receiving verification input. The application server 100 can be configured to verify booking data 112, weight data 114, or both such as, for example, booking number, container number, gross mass input, units, or the like in response to receiving the verification input. The verification webpage can include an embedded weight ticket image or link to the weight ticket image, controls for amending weight data 114, or both. In one example, the unique URL can be associated with the verification entity. Accordingly, the verification input received from the verification webpage can be validated to the verification entity. The application server 100 can be configured to transform the gross mass input into a verified gross mass in the weight data 114 in response to the validation input.

At process 166, the EDI message can be encoded to be indicative of any of the entity data 110, booking data, 112, and weight data 114 associated with the verified gross mass. For example, the EDI message can be indicative of the selected carrier and the verified gross mass. The server 100 can be configured to transmit the EDI message to the shipping portal 200 in response to the verified gross mass input. The shipping portal 200 can be configured to receive the EDI message from the server 100. The shipping portal 200 can be configured to transmit the verified gross mass to an ocean carrier data store 204 of the selected carrier and a terminal data store 206 of the maritime terminal associated with the selected carrier based on the EDI message. Additionally, the EDI message can be transmitted to an order entry system of the shipper, the freight forwarder, or both. Accordingly, the order entry system can update databases of the shipper, the freight forwarder, or both with weight values, a container number, or any other associated data of the database 108.

The method 120 of FIG. 4 can further include a process 170 for transmitting confirmation of delivery of the EDI message to the shipping portal 200. In one example, the application server 100 can be configured to continuously monitor the transmission to the shipping portal 200. The application server 100 can be configured to update the communication status of the weight data 114 in response to the transmission being confirmed as accepted. Accordingly, the communication status objects 142 can be updated to indicate the acceptance of the EDI message. Moreover, an alert indicating acceptance of the EDI message can be transmitted to the verification entity via a confirmation channel (e.g., verification alert parameters of the entity data 110) associated with the verification entity in response to the successful transmission of the EDI message.

It should now be understood that this disclosure address an internet-centric problem of maintaining data security of data stores kept by ocean carriers and shipping terminals, and accurately communicating the data to the data stores. To maintain data integrity of the data stores, access can be restricted to known entities such as shipping portals. Additionally, the communication of information can be restricted. For example, the data stores can be configured to accept data for adding to the data store, but not transmit the data instances from the data store. Accordingly, shippers may be denied access to the data stores, and excluded from viewing the contents of the data stores. The systems and methods described herein solve the internet centric problem by providing a user interface that receives input and generates data entry queries to the data stores. Accordingly, the shippers can accurately transmit the data to the data stores in an appropriate format. Moreover, the systems and methods described herein provide webpages and applications for viewing the records submitted to the data stores. Accordingly, the shippers can be provided with a summary that mirrors the corpus of the data stores without actually entering websites of the ocean carriers, shipping terminals, or shipping portals.

Moreover, this disclosure address an internet-centric challenge of alerting maritime terminals with time sensitive information when an originator of the time sensitive information is not capable of directly communicating with the data stores of the maritime terminal. The problem is solved by providing multiple input channels over which gross mass data can be transmitted, providing separate inputs for verifying the gross mass data, and transmitting an EDI message over a communication channel to provide the verified gross mass data. The gross mass data can be verified by a verification entity, even when the verification entity is not in direct control of the container. Thus, the gross mass can be verified even while the container is in transit by a freight forwarder, which would avoid delays in submitting the time sensitive verified gross mass data. Accordingly, containers can be timely received by the maritime terminal, and timely and safely loaded onto the vessel. In many circumstances, shippers can avoid supply chain issues, and spoilage of cargo.

While particular examples have been illustrated and described herein, it should be understood that various other changes and modifications may be made without departing from the spirit and scope of the claimed subject matter. Moreover, although various aspects of the claimed subject matter have been described herein, such aspects need not be used in combination. It is therefore intended that the appended claims cover all such changes and modifications that are within the scope of the claimed subject matter.

What is claimed is:

1. A system comprising:
a non-transitory memory to store machine readable instructions and data;
a processor to access the non-transitory memory and execute the machine readable instructions, the machine readable instructions causing the processor to:
provide to a device a booking web page comprising an ocean carrier control associated with a predefined list of ocean carriers, the predefined list of ocean carriers being stored in the non-transitory memory;
receive ocean carrier input data received at the ocean carrier control, wherein the ocean carrier input data characterizes a selected carrier from the predefined list of ocean carriers;
monitor continuously one or more input channels associated with one or more input devices for gross mass input data characterizing a gross mass of a container associated with a shipment scheduled for the selected carrier;
receive the gross mass input data from the one or more input channels;
generate a verification control to verify the gross mass of the container, wherein the verification control is associated with a verification entity for the container;
receive verification input data in response to generating the verification control, wherein the verification input data is indicative of a verification of the gross mass input;
validate that the verification input data is associated with the verification entity;
transform the gross mass input data into a verified gross mass input data based on the validation;
encode an electronic data interchange message (EDI) based on the verified gross mass input data and the ocean carrier input data; and
cause the EDI to be transmitted to a shipping portal to cause the shipping portal to transmit the verified gross mass to a carrier data store associated with the selected carrier and a terminal data store associated with a terminal associated with the selected carrier.

2. The system of claim 1, wherein the machine readable instructions further cause the processor to transmit a confirmation message via a confirmation channel associated with the verification entity.

3. The system of claim 1, further comprising the shipping portal, the shipping portal being configured to receives the EDI transmitted by the server and transmit the verified gross mass to the carrier data store associated with the selected carrier and the terminal data store associated with the terminal associated with the selected carrier.

4. The system of claim 1, wherein the booking webpage further comprises a booking number control, wherein the machine readable instructions cause the processor to receive booking number input data characterizing the shipment scheduled for the selected carrier, which is received at the booking number control, the shipment including at least the container.

5. The system of claim 4, wherein the machine readable instructions further cause the processor to evaluate the booking number input data relative to stored booking number input data characterizing one or more shipments scheduled for one more carriers of the predefined list of carriers.

6. The system of claim 5, wherein the machine readable instructions further cause the processor to reject the booking number input data in response to determining that the booking number input data matches the stored booking number input data.

7. The system of claim 5, wherein the machine readable instructions further cause the processor to:
accept the booking number input data in response to determining that the booking number input data does not match the stored booking number input data; and
store the booking number input data in the non-transitory memory.

8. The system of claim 4, wherein the machine readable instructions further cause the processor to provide a container information control web page comprising a container number control to the device.

9. The system of claim 8, wherein the machine readable instructions further cause the processor to receive container number input data identifying the container and associate the container number input data with both the ocean carrier data characterizing the selected carrier and the container.

10. The system of claim 9, wherein the machine readable instructions further cause the processor to evaluate the container number input data identifying the container relative to stored container number input data identifying one or more other containers associated with the booking number data characterizing the shipment.

11. The system of claim 10, wherein the machine readable instructions further cause the processor to reject the container number input data in response to determining that the container number input data matches the stored container number input data.

12. The system of claim 8,
wherein the container information control web page further comprises a gross mass control for receiving the gross mass input for the container;
wherein the machine readable instructions further cause the processor to receive the gross mass input data characterizing the gross mass of the container associated with the shipment.

13. The system of claim 1, wherein the machine readable instructions further cause the processor to receive the gross mass input data from an input channel associated with another device.

14. The system of claim 1, wherein the verification entity is one of a shipper or an agent acting on behalf of the shipper.

15. The system of claim 1, wherein the device comprises one of a smart phone, a tablet, a laptop computer and a desktop computer.

16. A system comprising:
a server comprising one or more processors and a non-transitory memory to store machine readable instructions and data, wherein the one or more processors is configured to access the non-transitory memory and execute the machine readable instructions, the machine readable instructions causing the one or more processors of the server to:
provide a booking web page to a booking device comprising an ocean carrier control associated with a predefined list of ocean carriers, the predefined list of ocean carriers being stored in the non-transitory memory;
receive ocean carrier input data received at the ocean carrier control, wherein the ocean carrier input data characterizes a selected carrier from the predefined list of ocean carriers;
monitor continuously one or more input channels associated with one or more input devices for gross mass input data characterizing a gross mass of a container associated with a shipment scheduled for the selected carrier;
receive the gross mass input data from the one or more input channels;
generate a verification control to verify the received gross mass input data, wherein the verification control is associated with a verification entity for the container;
receive verification input data, wherein the verification input data is indicative of a verification of the gross mass input;
validate that the verification input data is associated with the verification entity;
transform the gross mass input data into a verified gross mass input data based on the validation;
encode an electronic data interchange message (EDI) based on the verified gross mass input data and the ocean carrier input data; and
transmit the EDI to a shipping device;
the shipping device comprising one or more processors and a non-transitory memory to store machine readable instructions and data, wherein the one or more processors of the shipping device is configured to access the non-transitory memory of the shipping device and execute the machine readable instructions, the machine readable instructions causing the one or more processors of the shipping device to:
receive the EDI transmitted by the server; and
transmit the verified gross mass to the carrier data store associated with the selected carrier and the terminal data store associated with the terminal associated with the selected carrier based on the received EDI.

17. The system of claim 16, wherein the machine readable instructions further cause the one or more processors of the server to transmit a confirmation message via a confirmation channel associated with the verification entity.

18. The system of claim 16, wherein the machine readable instructions further cause the one or more processors of the server to receive the gross mass input data from an input channel associated with a mobile device.

19. The system of claim 16, wherein the verification entity is one of a shipper or an agent acting on behalf of the shipper.

20. The system of claim 1, wherein the booking device comprises one of a smart phone, a tablet, a laptop computer and a desktop computer.
